(19) United States
(12) Patent Application Publication
(10) Pub. No.: US 2011/0189385 A1
(43) Pub. Date: Aug. 4, 2011

(54) PRODUCTS AND METHODS FOR REPAIRING CONCRETE SURFACES

(76) Inventor: Darryl F. Manuel, Yardley, PA (US)

(21) Appl. No.: 12/940,104

(22) Filed: Nov. 5, 2010

Related U.S. Application Data
(60) Provisional application No. 61/301,053, filed on Feb. 3, 2010.

(51) Int. Cl. B05D 3/12; C04B 14/02

(52) U.S. Cl. 427/140; 106/712

(57) ABSTRACT

Products and methods for treating imperfections in concrete surfaces, especially floors being polished, wherein the products are used with grinding equipment, and combine with concrete powder or fines to fill, e.g., cracks, holes and voids and blend with the existing color of the concrete surface thereby yielding a consistent, natural looking surface.

### FIELD OF THE INVENTION

The present invention relates to products and methods for treating concrete surfaces. More specifically, the present invention relates to products and methods for repairing imperfections in existing concrete surfaces such as concrete floors being ground or polished.

### BACKGROUND OF THE INVENTION

As explained by the Portland Cement Association (www.cement.org/basics/concretebasics_concretebasics.asp), in its simplest form, concrete is a mixture of cement paste and aggregates. The paste (composed of portland cement and water) coats the surface of the aggregates and hardens by hydration of the cement to form a rock-like mass known as concrete.

Concrete has several desirable traits including the fact that it is plastic and malleable when newly mixed, and strong and durable when hardened. The key to achieving strong, durable concrete rests in the careful proportioning and mixing of its ingredients. For example, a concrete mixture that does not have enough paste to fill all the voids between the aggregates tends to produce rough, honeycombed surfaces and porous concrete. A mixture with an excess of cement paste will produce a smooth surface; however, the resulting concrete is likely to shrink more and be uneconomical. A properly designed concrete mixture possesses the desired workability for the fresh concrete and the required durability and strength for the hardened concrete. Typically, a mix is about 10 to 15 percent cement, 60 to 75 percent aggregate and 15 to 20 percent water. Entrained air in many concrete mixes may also take up as much as another 5 to 8 percent.

Cement and water form a paste that coats each particle of stone and sand. Through a chemical reaction called hydration, the cement paste hardens, adheres to the aggregate and gains strength. A significant percentage of cement is tricalcium silicate which, when hydrated, produces calcium silicate hydrate and calcium hydroxide. (HFW Taylor, “Cement Chemistry,” 2^{nd} Ed., Thomas Telford, 1997, 113-156; P.C. Hewlett, “Lea's Chemistry of Cement and Conrete,” 4^{th} Ed., Elsevier, 1997, 251-289.) The character of the concrete is determined by quality of the paste. The strength of the paste, in turn, depends on the ratio of water to cement. The water-cement ratio is the weight of the mixing water divided by the weight of the cement. High-quality concrete is produced by lowering the water-cement ratio as much as possible without sacrificing the workability of fresh concrete. Generally, using less water produces a higher quality concrete provided the concrete is properly placed, consolidated, and cured. The primary binding agent in concrete is understood to be an amorphous gel of calcium silicate hydrate having an indefinite ratio of calcium to silicate, ranging from 1.2 to 2.3 calcium atoms per silicate unit. R. J. M. Pellenq, et al., A realistic molecular model of cement hydrates, PNAS, 2009, www.pnas.org/content/106/38/16102.full.

Calcium in mature concrete in excess of that combined in calcium silicate hydrate is present primarily as crystalline (insoluble) calcium hydroxide. Any free water within the concrete exists as a saturated solution of calcium hydroxide. Mature concrete also contains varying amounts of unhydrated cement, the quantity depending on the initial water cement ratio of the concrete mixture and the curing conditions employed. Curing is defined as action taken to maintain necessary conditions to allow hydration of cement. The most important of these conditions is the prevention of loss by evaporation of the mixing water initially contained in the concrete.

Aggregates are chosen carefully and comprise about 60 to 75 percent of the total volume of concrete. The type and size of the aggregate mixture depends on the thickness and purpose of the final concrete product. Relatively thin building sections call for small coarse aggregate, though aggregates up to six inches (150 mm) in diameter have been used in large dams. A continuous gradation of particle sizes is desirable for efficient use of the paste. In addition, aggregates should be clean and free from any matter that might affect the quality of the concrete.

Soon after the aggregates, water, and the cement are combined, the mixture begins to harden. All portland cements are hydraulic cements that set and harden as a result of a chemical reaction with water. “Hydraulic cement” means a material which will set and harden in the presence of excess water. This reaction (i.e., hydration) causes a node to form on the surface of each cement particle. (See e.g., www.cement.org/basics/concretebasics_concretebasics.asp). The node grows and expands until it links up with nodes from other cement particles or adheres to adjacent aggregates. The building up process results in progressive stiffening, hardening, and strength development. Once the concrete is thoroughly mixed, it is typically poured and formed before it becomes too stiff.

During placement, the concrete is consolidated to compact it within a desired form and to eliminate potential flaws, such as honeycombs and air pockets. For slabs, concrete is left to stand until the surface moisture film disappears. Curing begins after the exposed surfaces of the concrete have hardened sufficiently to resist marring. Curing ensures the continued hydration of the cement and the strength gain of the concrete. Concrete surfaces are cured by sprinkling with water fog, or by using moisture-retaining fabrics such as burlap or cotton mats. Other curing methods prevent evaporation of the water by sealing the surface with plastic or special sprays (curing compounds). The longer the concrete is kept moist, the stronger and more durable it will become. The rate of hardening depends upon the composition and fineness of the cement, the mix proportions, and the moisture and temperature conditions. Most of the hydration and strength gain take place within the first month of concrete's life cycle, but hydration continues at a slower rate for many years which is why concrete continues to get stronger as it gets older.

As explained above, concrete is susceptible to surface imperfections which manifest themselves in a variety of forms some of which are cracks, holes, and voids. Not surprisingly, such imperfections detract from the overall appearance and function of a hardened concrete surface. This is particularly true when the concrete surface has been polished. While it is generally understood that many imperfections in concrete can be filled with various materials, these materials (and the techniques for applying them) have only been marginally successful in repairing concrete and even less successful in restoring uniform, aesthetically pleasing concrete surfaces. These materials (and the techniques for applying them) include: latex fill, grouting and clear epoxy.

The use of alkali silicate solutions on established concrete surfaces to improve such concrete properties as abrasion resistance and permeability is generally known in the art. More recently, such solutions have also been used as an aid in polishing concrete to create attractive, durable concrete surfaces. However, these attractive surfaces which often include various levels of shine as well as the incorporation of various colors are, from time to time, prone to cracking, crazing, spalling as well as the formation of voids and holes in the concrete. Such damage significantly detracts from the overall appearance of an otherwise attractive concrete surface. While various techniques have been tried for repairing polished concrete, there are no known treatment products or methods that effectively repair damaged concrete such that the concrete surface is essentially restored to its original condition.

I have discovered novel treatment products for repairing concrete surfaces as well as novel methods of repairing concrete surfaces, which include the use of concrete particles, fines and/or dust, such that the surfaces are essentially restored to their original condition.

### SUMMARY OF THE INVENTION

In accordance with one aspect of the present invention novel products are provided which treat, repair and restore existing concrete surfaces in the course of grinding these surfaces. More specifically, one embodiment of the present invention is the use of a treatment product applied in the grinding process comprising a binder, at least one wetting agent, a calcium sequestrant, a catalyst, pigment dispersants and water. Another embodiment of the invention, which is more effective in repairing larger cracks, holes, pop-outs and the like, employs a product comprised of a water reducer, a defoamer and a stabilizer together with dust generated in the grinding process. Another aspect of the present invention is a release agent that is applied to concrete grinding equipment to ease the removal of concrete slurries created during the process of grinding a concrete surface. The release agent is a combination of hydroxyethyl cellulose, sodium lauryl sulfate, alkyl amines and water.

In a second aspect of the present invention, there are provided novel methods for treating, repairing and restoring concrete surfaces. More specifically, one embodiment of the present invention is a method which comprises applying an embodiment of the novel treatment product to a concrete surface and using a grinding device to grind the concrete surface such that the treatment product mixes and reacts with concrete particles from the ground concrete surface to form a product that fills imperfections such as holes, cracks, voids while grinding the concrete surface. Another embodiment of the invention, which is more effective in repairing larger concrete imperfections, comprises the steps of grinding a concrete surface, collecting concrete particles from the ground concrete surface, mixing a concrete treatment product with at least a portion of the concrete particles to obtain a paste-like product and applying the paste-like product to the hole, crack or void.

It is therefore an object of the present invention to repair imperfections in concrete surfaces, including fill holes, cracks and voids, with a product that results in the same or nearly the same color as the existing concrete surface as well as similar hardness, porosity, and break resistance as the existing concrete. It follows that another object of the present invention is to repair concrete such that the repair is essentially invisible to the naked eye and therefore results in a uniform or consistent concrete surface. Another object of the present invention is to provide a product and method for using the product which quickly repairs imperfections in concrete surfaces. Still another object of the present invention is to provide a treatment product that improves the gloss and clarity of a concrete surface while also yielding a smoother, denser surface. Yet another object of the invention is to provide a product that does not interfere with intentional staining or dyeing of a concrete surface. These and other objectives of the present invention will be made more apparent in the detailed description of the invention.

### DETAILED DESCRIPTION OF THE INVENTION

The present invention is directed, in one aspect, to products used to repair imperfections that exist in concrete surfaces, especially floors. The term “concrete surfaces” includes, but is not necessarily limited to, surfaces that comprise cementitious terrazzo. Such imperfections include, but are not limited to, cracks, holes, voids, pop-outs and bug-holes. The repair of such imperfections is especially important when the concrete surface is polished and/or coated to improve its shine and overall aesthetic appearance.

Several products exist which have been used to repair imperfections in concrete. Such products contain a variety of ingredients but tend to be latex, epoxy and grout-based. These products have only been marginally successful in repairing imperfections in concrete and even less successful in repairing concrete such that the products provide a uniform and consistent concrete surface. As shown in Table I below, the products of the present invention are superior to known latex, grout and epoxy products used to repair imperfections in concrete.

TABLE I
Products Used to Repair Concrete Imperfections

| Inventive Products | Latex Fill | Grouting | Clear Epoxy |
|---|---|---|---|
| Uses concrete particles, | Uses dust from concrete | Introduces cement | Fills with a clear epoxy |
| fill and/or dust from | to fill imperfections | colors to the concrete | |
| concrete to fill | | surface | |
| imperfections | | | |
| Mixes with ground | Mixes with the grinding | Mixed and troweled by | Mixed and troweled by |
| concrete particles, fill | dust and fills the voids | hand into the voids of | hand into the voids of |
| and/or dust and fills | while grinding | the concrete surface | the concrete surface |
| concrete imperfections | | | |
| while grinding | | | |
| Filled imperfections are | Filled imperfections are | Filled imperfections dry | Filled imperfections dry |
| barely noticeable | barely noticeable | the color of the cement | and are clear and shiny |
| Cures in 1 hour | Cures in X hours | Cures in a few hours | Cures in 8 hours |
| Natural color | Natural color | Repaired areas stand out | Repaired areas stand out |
| Uses silicate which | Relies on latex to “hold” | Relies on latex to “hold” | Relies on a mechanical |
| contributes to the | the repair to the concrete | the repair to the concrete | bond to adhere to the |
| hardness of the concrete | surface | surface | concrete surface |
| surface | | | |
| Increases the concrete | Reduces the potential | Reduces the potential | Shines differently than |
| surface clarity and shine | shine | shine | concrete surface |
| Accepts silicate | Repels silicate hardener | Repels silicate hardener | Repels silicate hardener |
| hardener densifier | densifier | densifier | densifier |
| Reliable color stain | Not reliable color stain | Not reliable color stain | Not reliable color stain |
| Diamond polishable | Diamond polishable | Diamond polishable | Diamond polishable |

A first embodiment of the present invention is a treatment product for a concrete surface which comprises a binder, at least one wetting agent, a calcium sequestrant, a catalyst, a dispersant and water as a solvent. The treatment product of this embodiment effectively repairs relatively small imperfections in concrete surfaces including, but not limited to, air holes, aggregate pop-outs, voids, micro-cracks, spider cracks. The term “small imperfections” is intentionally not specifically defined as it will depend on many factors, including the type, shape, depth, diameter and circumference of the imperfection. Generally, the treatment product of this embodiment is most effective in repairing imperfections less than about one-half inch in size. This includes, for example, ½ inch diameter bug-holes, ½ inch deep voids, and ½ inch wide lengthy cracks.

While known concrete repair products tend to discolor the concrete surface and stand out from the original surface, the treatment product of the present invention repairs surface imperfections while blending into the existing color of the concrete yielding a consistent looking surface. The effectiveness of the treatment product of this first embodiment results, in part, from its ability to combine and react with residual cement and calcium hydroxide in concrete particles, powder, fines, and debris that result during grinding the concrete surface. This first embodiment of the present invention is further described in the product sheet attached hereto as Exhibit A which identifies the embodiment by its tradename, Certi-Shine® Fusion™.

Referring now to Table II, preferably, the first embodiment of the present invention comprises: a reactive salt of silicic acid; a non-ionic polyether surfactant; an amino alcohol; a chelating agent; a calcium salt; a pigment dispersant; and water. The first embodiment of the present invention is not limited to specific compounds but instead can include various ingredients of the same or similar class only some of which are identified in Table II below. The total solids of the first embodiment of the present invention is 18-45%; preferably 30-45%; more preferably 30-35%; still more preferably 32-34%; most preferably 32.5-33.5%.

TABLE II
Function of Chemical Ingredients and Some Alternatives

| Function | Ingredient(s) | Examples |
|---|---|---|
| binder | salt of silicic acid | potassium silicate, lithium |
| | | silicate, sodium silicate |
| wetting agent | non-ionic polyether | Triton ®-X 100, Nonidet |
| | surfactant | P-40 and Igepal |
| wetting agent | amino alcohol | AMP95, DMAMP-80 |
| calcium | chelating agent | Versene100, |
| sequestrant | | ethylenediaminetetracetic |
| | | acid (EDTA), |
| | | diaminopropanoltetracetic |
| | | acid, |
| | | diethylenetriaminepentaacetic |
| | | acid, N-(hydroxyethyl)- |
| | | ethylenediaminetriacetic acid, |
| | | nitrilotriacetic acid |
| catalyst/ | calcium salt | calcium nitrate, calcium |
| accelerator | | chloride, calcium bromide, |
| | | calcium iodide, calcium |
| | | acetate, calcium formate, |
| | | calcium propionate and |
| | | calcium nitrite, calcium |
| | | nitrate |
| dispersant | tetramethyl-5-decyne-4, | ZetaSperse ®1200, |
| | 7-diol, 2,4,7,9-, | Surfynols ®, Igepals ®, |
| | propylene glycol, | Acrylsols ®, Tamols ® |
| | ethoxylated alcohol | |
| solvent | water | potable, deionized |

As shown in Table II, the binder of the present invention is preferably a product containing a sufficient quantity of a salt of silicic acid and, most preferably, a product containing a sufficient quantity of potassium silicate. For example, Zacsil® 865 (Zaclon LLC, Cleveland, Ohio) is an aqueous solution containing approximately 28-41% by weight of potassium silicate that can be used effectively in preparing the first embodiment of the present invention. Other salts of silicic acid, including lithium silicate and sodium silicate can also be used effectively.

Various wetting agents can be used successfully in the present invention. Preferred wetting agents are non-ionic polyether surfactants and amino alcohols. For example, Triton®-X 100 (Dow Chemical Company, Midland, Mich.), Nonidet P-40 (Roche, Mannheim, Germany) and Igepal (Sigma-Aldrich Inc., Saint Louis, Mo.) are all non-ionic surfactants whereas AMP-95 and DMAMP-80 (Angus Chemical Company, Buffalo Grove, Ill.) are examples of amino alcohols that can be used effectively as wetting agents in the first embodiment of the present invention.

Additionally, various chelating agents or, more specifically, calcium sequestrants can be used effectively to form the first embodiment of the present invention. The calcium sequestrant prevents calcium salts from reacting while the product is stored before use thereby ensuring the stability of the product. Preferably, the calcium sequestrant is one of EDTA or a derivative of EDTA. For example, Versene™ 100 (Dow Chemical Company, Midland, Mich.) can be used effectively as a chelating agent/calcium sequestrant in the products of the present invention.

It is also preferred that the accelerator catalyst is a calcium salt; most preferably, the catalyst is one selected from the group of calcium chloride, calcium bromide, calcium iodide, calcium acetate, calcium formate, calcium propionate, calcium nitrite and calcium nitrate.

A dispersant is added to the treatment product to accelerate and enhance the wetting of the fine particles generated during grinding. Various dispersants are effective in the treatment product of the first embodiment including, but not limited to, Surfynols, Igepals, Acrylsols and Tamols (all trade names). For example, ZetaSperse® (Air Products and Chemicals, Inc., Allentown, Pa.) can be used effectively as a dispersing additive in the products of the present invention.

Various types of water can serve as an effective solvent for the first embodiment of the present invention, including portable water, purified water, deionized water, and distilled water. Preferably, the first embodiment of the present invention contains portable water.

The various ingredients and examples listing in Table II are not intended to be limiting. Instead, a person of ordinary skill in the art would understand and appreciate that suitable alternative ingredients exist which function in the same or similar manner as the identified ingredients and examples.

A second embodiment of the invention, which is more effective in repairing larger imperfections, is similar to the treatment product of the first embodiment but with some important chemical and physical property differences. The term “larger imperfections” is intentionally not specifically defined as it will depend on many factors, including the type, shape, depth, diameter and circumference of the imperfection. Generally, the treatment product of this embodiment is most effective in repairing imperfections greater than about one-half inch in size.

Like the treatment product of the first embodiment, the second embodiment comprises a binder, a wetting agent, a calcium sequestrant, a catalyst and a dispersant. However, while the carrier is water, it does not include the addition of water. Also, unlike the treatment product of the first embodiment, the product of the second embodiment includes a defoamer, a water reducer and a dispersion stabilizer. Various types of defoamers, water reducers and stabilizers can be used effectively in the second embodiment of the present invention. For example, Dee Fo 725E (Ultra Additives Inc., Bloomfield, N.J.) is known to be an effective defoamer, Catexol™ 1000N (Axim Italcementi Group, Middlebranch, Ohio) is known to be an effective water reducing agent, and Min-U-Gel® 400 (ActiveMinerals International, LLC, Hunt Valley, Md.), a hydrous magnesium aluminum silicate product, is known to be an effective dispersion stabilizer.

Like the treatment product of the first embodiment, the second embodiment combines and reacts with residual cement and calcium hydroxide in concrete powder to produce a consistent, natural looking repair. Thus, similar to the treatment product of the first embodiment, the second embodiment provides an advanced product for the treatment and repair of concrete surfaces, especially floors. This second embodiment of the present invention is further described in the product sheet attached hereto as Exhibit B which identifies the embodiment by its tradename, Certi-Shine® Fusion™ LG. Higher solids are maintained in the second embodiment. The total solids of the second embodiment of the present invention is 25-48%; preferably 38-45%; more preferably 42-45%; still more preferably 42.5-43.5%; most preferably 42.8-43.2%.

It is generally known that, when grinding equipment is used on a concrete surface, heat is generated and water entrapped in the concrete becomes available to combine and react with cement, calcium hydroxide and other ingredients of the cured concrete. This results in a glazing product that tends to build-up on the surfaces of the grinding equipment often rendering it ineffective. This is especially true when the cured concrete surface is wet or, for example, when the products of the first and second embodiments of the present invention are used to repair imperfections in a concrete surface.

It has been discovered that when a release agent is applied to concrete grinding equipment prior to and during its use, the concrete build-up or glazing generated during the process of grinding a concrete surface is much more easily removed from the grinding equipment than without its use. This enables the grinding equipment to be more effectively and efficiently used to grind concrete surfaces. Accordingly, another aspect of the present invention relates to a novel release agent as further described herein.

In a preferred embodiment, the release agent of the present invention has been found to be effective as a spray that comprises hydroxyethyl cellulose, sodium lauryl sulfate, an ethoxylated alkyl amine and water. For example, Cellosize (Union Carbide, Danbury, Conn.), Calfoam SLS-30 (Textile Chemical Co., Reading, Pa.), and E-DT-3 (Tomar Products, Inc., Milton, Wis.) are known to be effective release product ingredients containing hydroxyethyl cellulose product, sodium lauryl sulfate and ethoxylated alkyl amine, respectively. The release agent of the present invention is further described in the product sheet attached hereto as Exhibit C which identifies the embodiment by its tradename, Certi-Shine® Fusion™ Release.

In addition to various products of the present invention, a second aspect of the present invention relates to methods of repairing imperfections in concrete surfaces. One such method comprises the steps of: dispensing the treatment product of the first embodiment of the inventive product onto a concrete surface; and using a grinding device to grind the concrete surface having the treatment product dispensed on it such that the treatment product mixes and reacts with concrete particles from the ground concrete surface to form a product that fills imperfections in the concrete surface. It is preferred that, prior to grinding the concrete surface, the release product of the present invention is applied to the grinding device, especially the grinding surfaces of the grinding device.

A second method of the present invention involves using the treatment product of the second embodiment described above to fill relatively large imperfections in a concrete surface. Simply stated, the steps of this method include: collecting an adequate amount of dry concrete particles or fines generated by grinding from a concrete surface to be repaired; mixing the concrete fines with the treatment product of the second embodiment to form a paste; and applying the paste to the imperfections in the concrete surface.

The invention will now be further described by the following examples, which are intended to be illustrative rather than limiting.

### EXAMPLES

### Example 1

A concrete treatment product in accordance with the first embodiment of the present invention was prepared by separately weighing the following ingredients and subsequently mixing them in a Lightnin 10 HP (Mixco) slow speed mixer. The ingredients were added to the mixer, which operated between 60-125 rpm, in the order in which they appear in Table III and mixed for approximately 30 minutes.

TABLE III

| Ingredient | Weight (lbs.) | Volume (gal.) |
|---|---|---|
| water | 221.057 | 26.548 |
| potassium silicate | 821.998 | 70.862 |
| X-100/CA 630 | 3.120 | 0.354 |
| AMP 95 | 3.120 | 0.398 |
| Versene 100 | 16.116 | 1.477 |
| calcium nitrate 66% | 3.806 | 0.313 |
| Zetasperse 1200 | 0.427 | N/A |

The concrete treatment product of Example 1 was determined to have the properties set forth in Exhibit A.

### Example 2

A concrete treatment product in accordance with a second embodiment of the present invention was prepared by separately weighing the following ingredients and subsequently mixing them in a Lightnin (Mixco) slow speed mixer for approximately 30 minutes. The ingredients were added to the mixer in the order in which they appear in Table IV.

TABLE IV

| Ingredient | Weight (lbs.) | Volume (gal.) |
|---|---|---|
| potassium silicate | 997.99 | 86.03 |
| Cataxol-1000N | 57.54 | 5.75 |
| Versene 100 | 38.36 | 3.51 |
| calcium nitrate 66% | 4.61 | 0.42 |
| Zetasperse 1200 | 2.60 | 0.29 |
| Dee Fo 725 E | 4.85 | 0.59 |
| Min-U-Gel 400 | 78.02 | 3.57 |

The concrete treatment product of Example 2 was determined to have the properties set forth in Exhibit B.

### Example 3

The concrete release product in accordance with the present invention was prepared by separately weighing the following ingredients and subsequently mixing them in a Charles Ross & Son Company (Hauppauge, N.Y.) high speed, in-line emulsifier, homogenizer mixer, which operated at about 5000 rpm and about 85-90 gallons per minute. The ingredients were added to the mixer in the order in which they appear in Table V. The product was passed through the high speed mixer twice.

TABLE V

| Ingredient | Weight (lbs.) | Volume (gal.) |
|---|---|---|
| water | 206.861 | 24.843 |
| Cellosize | 1.833 | N/A |
| water | 593.063 | 71.224 |
| Calfoam SLS-30 | 20.687 | 2.414 |
| E-DT-3 | 10.349 | 1.381 |

The concrete treatment product of Example 3 was determined to have the properties set forth in Exhibit C.

### Example 4

Numerous imperfections in a concrete floor, including small cracks, voids and holes, were repaired by a preferred method of the present invention. More specifically, approximately a one thousand square foot concrete floor was repaired using the following procedure:
1. The release product of the present invention was sprayed on the grinding surfaces of a 3 head planetary grinding device (HTC Model 500, Sweden) having a 16 to 30 grit metal-bond diamond pad.
2. The grinding device was used to grind (“flatten”) the affected area of the concrete floor for approximately 30 minutes while collecting the dust generated in a vacuum device and setting it aside for later use.
3. The same area of the floor was further ground using the same grinding pad but at 90° (“crosshatch”) to the previous grinding step (Step 2) for approximately 15 minutes without subsequently collecting the dry concrete particles or fines from the floor.
4. The concrete treatment product of Example 1 was dispensed on the floor in a quantity of approximately one gallon of treatment product for each 100-150 square feet of floor. Note: Sufficient product should be used such that, during the subsequent grinding step (Step 5), the product and cement fines will form a slurry, which is spread just ahead of the grinder.
5. The floor was further ground, this time with a 40 to 80 grit diamond grit pad, at 90° (“crosshatch”) to the previous grinding step (Step 3) for approximately 30 minutes.
6. The floor was further ground using the same pad but at 90° (“crosshatch”) to the previous grinding step (Step 5) for approximately 20 minutes. Note that additional treatment product should be applied to the floor, as necessary, prior to this step.
7. The floor was inspected to ensure that all of the imperfections were covered with the treatment product-concrete fine slurry. The slurry was allowed to harden for approximately one hour.
8. An additional 1.25 gallons (approx.) of the treatment product was placed on the floor after which the floor was further ground, using 80 to 120 grit diamond grit pad, but at 90° (“crosshatch”) to the previous grinding step (Step 6) for approximately 30 minutes.
9. The floor was further ground with the same pad but at 90° (“crosshatch”) to the previous grinding step (Step 8) with an additional 1.25 gallons (approx.) of the treatment product for approximately 20 minutes. Once again, the grinding created a slurry that finished filling several shallow holes and voids in the floor. The grinding is not completed until the floor is about dry.
10. A second inspection on the floor was performed to confirm that there were no visible imperfections.
11. Approximately one hour after the second inspection, the floor was polished with a resin-bond diamond pad.

### Example 5

The procedure for repairing a concrete floor as described in Example 4 was repeated except for the following differences. After collecting the concrete fines (Step 3), the fines were mixed with the treatment product described in Example 2 in a ratio of about 60% by weight concrete fines to about 40% by weight treatment product to form a paste. The paste was then applied to a putty knife and used to fill relatively large cracks and holes in the concrete surface.

It is to be understood that the above-described arrangements and examples are only illustrative of the application of the principles of the present invention. Numerous modifications and alternative arrangements may be devised by those skilled in the art without departing from the spirit and scope of the present invention and the appended claims are intended to cover such modifications and arrangements.

I claim:

1. A treatment product for a concrete surface comprising: a binder, at least one wetting agent, a chelating agent, a catalyst, a pigment dispersant and water.

2. A treatment product for a concrete surface comprising: a binder, at least one wetting agent, a chelating agent, a catalyst, a pigment dispersant, a defoamer, a water reducer and a stabilizer.

3. A release product for grinding concrete surfaces comprising hydroxyethyl cellulose, sodium lauryl sulfate, an ethoxylated alkyl amine and water.

4. The treatment products of claim 1 or 2, wherein the binder is a salt of silicic acid.

5. The treatment product of claim 4, wherein the salt is a potassium salt, a lithium salt, or a sodium salt.

6. The treatment products of claim 1 or 2, wherein the wetting agent is a non-ionic polyether surfactant or an amino alcohol.

7. The treatment products of claim 1 or 2, wherein the chelating agent is a calcium sequestrant.

8. The treatment products of claim 7, wherein the calcium sequestrant is EDTA or a derivative thereof.

9. The treatment products of claim 1 or 2, wherein the catalyst is a soluble calcium salt.

10. The treatment products of claim 9, wherein the calcium salt is selected from the group consisting of calcium chloride, calcium bromide, calcium iodide, calcium acetate, calcium formate, calcium propionate, calcium nitrite and calcium nitrate.

11. A release product of claim 3, wherein the product is in the form of a spray.

12. A method of repairing a concrete surface imperfection comprising the steps of:
a) dispensing the treatment product of claim 1 on the concrete surface; and
b) using a grinding device to grind the concrete surface;
wherein the treatment product mixes and reacts with concrete particles from the ground concrete surface to form a fill product, and
wherein the fill product fills the imperfection while grinding the concrete surface.

13. The method of claim 12, further comprising the step of applying the release product of claim 3 to the grinding device prior to grinding the concrete surface.

14. A method of repairing a concrete surface imperfection comprising the steps of:
a) dry grinding a concrete surface with a grinding device;
b) collecting concrete particles from the ground concrete surface;
c) mixing the treatment product of claim 2 with at least a portion of the concrete particles to obtain a paste-like product; and
d) applying the paste-like product to the imperfection.

15. The method of claim 14, further comprising the step of applying the release product of claim 3 to the grinding device prior to dry grinding the concrete surface.

16. The method of claim 14, further comprising repairing the concrete surface in accordance with the method recited in claim 11.
